(19) United States
(12) Patent Application Publication
(10) Pub. No.: US 2005/0155859 A1
(43) Pub. Date: Jul. 21, 2005

(54) Insulation material and gas sensor

(76) Inventors: Bernd Schumann, Rutesheim (DE); Gudrun Oehler, Stuttgart (DE); Detlef Heimann, Gerlingen (DE); Berbdt Cramer, Leonberg (DE)

Correspondence Address: KENYON & KENYON, ONE BROADWAY, NEW YORK, NY, 10004, US

(21) Appl. No.: 10/508,141

(22) PCT Filed: Jan. 29, 2003
(86) PCT No.: PCT/DE03/00234

(30) Foreign Application Priority Data
Mar. 19, 2002 (DE) 102 12 018.8

(51) Int. Cl. G01N 27/26

(52) U.S. Cl. 204/426

(57) ABSTRACT

An insulating material for an electric component is provided, including sintered aluminum oxide to which a substance is added, the substance being deposited at the grain boundaries of the aluminum oxide and repressing the mobility of ions. In addition, a gas sensor is described having an insulating layer made of such an insulating material.

### FIELD OF INVENTION

The present invention relates to an insulating material for an electric component.

### BACKGROUND INFORMATION

A gas sensor having at least one layer made up of a ceramic solid electrolyte, at least two measuring electrodes, and at least one insulating layer for an electric component may be designed, for example, as a nitrogen oxide sensor or as a lambda probe.

A gas sensor, described in German Published Patent Application No. 199 41 051 and designed as a broad band lambda probe, includes a ceramic solid electrolyte base and multiple electrodes which are applied in cavities and on the outside of the solid electrolyte. The electrodes are each connected to a supply lead which has a terminal contact. A heater, embedded in the solid electrolyte, is electrically insulated and heats up the gas sensor to an operating temperature of 750° C., for example.

To galvanically decouple the electrically operated heater from the electrodes and the solid electrolyte, the heater is delimited on both sides by an insulating material which is designed as a layer and is made of aluminum oxide. The heater itself, for example, is made of a noble metal, such as platinum.

In order to minimize a two-way coupling of the electrode potentials, the supply leads of the electrodes may be insulated. This may be necessary, for example, in the case of a nitrogen oxide sensor according to the multi-cavity principle. The insulation of the supply leads may be made up of one or more aluminum oxide layers.

However, it has been shown that the aluminum oxide insulating layers have a residual conductivity which may result in signal interferences by the heater or in potential changes due to a two-way coupling of the electrodes. The residual conductivity is essentially the result of contaminations of the aluminum oxide, of the solid electrolyte, of the noble metal of the heater, and of the electrode supply leads.

The points of high ionic mobility in the ceramic aluminum oxide are the grain boundaries in the respective layer. In particular mobile ions, such as alkali metal ions, may move at these points, thereby adding to the electric conductivity of the respective insulating layer. Alkali metal contaminations, in particular sodium ions and/or potassium ions, from the electrode material, the solid electrolyte material, and/or the heater material may, for example, penetrate the aluminum oxide layer at the grain boundaries, thereby adding to the electric conductivity.

### SUMMARY OF THE INVENTION

An insulating material according to an example embodiment of the present invention in which a substance is added to the aluminum oxide, the substance being deposited at the grain boundaries of the aluminum oxide and repressing the mobility of ions, may minimize the residual conductivity of the aluminum oxide and retain a sufficiently low value, even at high operating temperatures.

An example embodiment of the present invention also relates to a gas sensor. Use of the insulating material as an insulating layer for an electric component of the gas sensor relative to the solid electrolyte may minimize the danger of signal interferences by the electric component or of potential changes due to a two-way coupling of the electrodes.

The substance added to the aluminum oxide remains at the grain boundaries, even at the high operating temperatures of the gas sensor, which are between 700° C. and 1,000° C., for example. There is no further distribution in the aluminum oxide layer. The mobility of contaminations, e.g., of alkali ions such as Na⁺ or K⁺, is thus also effectively repressed.

The electric component may be a resistance heater of a gas sensor or a supply lead of an electrode of a gas sensor, for example. The insulating layer may be arranged between the appropriate electric component and the solid electrolyte.

The substance, repressing the ion mobility, is added to the aluminum oxide prior to sintering the insulating layer, that is, for example, in the form of a fine powder or a coating on the aluminum oxide grains to be sintered. However, the substance may also be added as a solution to screen processing pastes which are used for manufacturing the insulating material.

According to an example embodiment of the insulating material according to the present invention, the substance, deposited at the grain boundaries of the aluminum oxide and repressing the ion mobility, is composed of an alkaline earth compound. The alkaline earth compound may represent a barium compound and/or a strontium compound.

The alkaline earth compound, which is added to the aluminum oxide base material during the manufacture of the insulating layer, may be composed, in particular, of a barium sulfate, a barium aluminate such as BaAl₂O₄ or BaAl₄O₇, a barium hexaaluminate, celsian, a celsian glass and/or a slawsonite glass on the basis of the alkaline earth metals strontium and barium. The alkaline earth compound may represent another barium alumosilicate or strontium alumosilicate.

The alkaline earth ions may also be added to the aluminum oxide base material in the form of an oxide, carbonate, or nitrate and then sintered together.

The substance, added to the aluminum oxide base material, may contain an excess of the alkaline earth metal ion since the ion mobility-repressing effect of the added substance may essentially be based on the size of the alkaline earth ions. The Ba²⁺ ion has a size of approximately 140 pm and the Sr²⁺ ion has a size of approximately 122 pm.

Since the Ba²⁺ ion represents the larger ion, its effect with regard to the residual conductivity of the insulating material may be greater compared to the Sr²⁺ ion. However, most acid soluble barium compounds are toxic if they are used in the process in the form of an oxide or carbonate. Exceptions include the above-mentioned compounds of barium sulfate, barium aluminate, barium hexaaluminate, celsian, and other barium alumosilicates not discussed here in greater detail.

The substance, added to the insulating material, may have a concentration of up to 50 percent by weight according to an example embodiment of the present invention. In a gas sensor having a solid electrolyte base element it should be pointed out that, with increasing concentration, the tendency increases for the alkaline earth component to diffuse into the solid electrolyte made of zirconium dioxide for example. In addition, the hydrothermal stability of the insulating material decreases with increasing concentration. Therefore, depending on the requirement and the added component, the concentration of the substance may be limited to 1 percent by weight to 20 percent by weight.

Further example embodiments according to the present invention may be provided from the description, the drawing, and the claims.

### BRIEF DESCRIPTION OF THE DRAWING

FIG. 1 shows a cross section through a broad band lambda probe having insulating layers made of an insulating material according to an example embodiment of the present invention.

### DETAILED DESCRIPTION

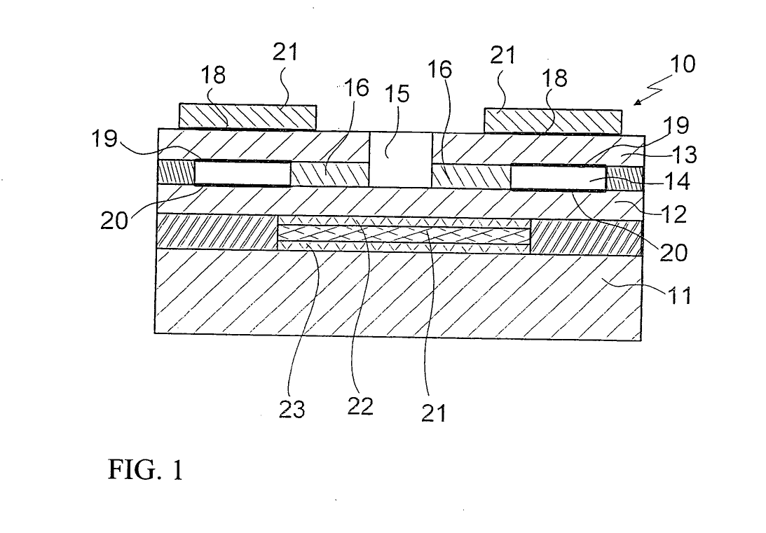

FIG. 1 shows an example configuration of a gas sensor 10. Gas sensor 10, configured as a planar element, represents a broad band lambda probe having a layered configuration including three ceramic films 11, 12, and 13 which are each formed by a solid electrolyte such as yttrium-stabilized zirconium oxide.

A measuring gap 14, having a porous diffusion barrier 16 and being configured as a measuring space, is arranged between ceramic films 12 and 13, the measuring gap being annular and being exposed to an exhaust gas via a gas inlet orifice 15 which is perpendicularly aligned to the plane of probe 10. The exhaust gas flows in an exhaust tract (not shown in greater detail) of a motor vehicle.

Furthermore, broad band lambda probe 10 includes an air reference channel which is connected to the surroundings. It is, however, arranged behind measuring gap 14 in the illustration selected in the figure. Therefore, the reference channel, not visible in the drawing, is arranged essentially on a level with measuring gap 14.

In addition, broad band lambda probe 10 includes two electrochemical cells, i.e., an oxygen pump cell, having an annular outside pump electrode 18, which surrounds gas inlet orifice 15, and an annular inside pump electrode 19, as well as a Nernst concentration cell. The Nernst concentration cell for its part has an annular concentration electrode 20 and a reference electrode (also not shown) delimiting the reference channel.

Outside pump electrode 18 is provided with an annular, porous protective layer 21 to protect against corrosive exhaust gas constituents.

A heater 21, with which the operating temperature of broad band lambda probe 10 is adjustable, is arranged between film layers 11 and 12 made of yttrium-stabilized zirconium oxide. The operating temperature may be, for example, approximately 750° C.

According to an example embodiment of the present invention, heater 21, representing a resistance heater, is embedded between two insulating layers 22 and 23 and is thus electrically insulated with respect to solid electrolyte layers 11 and 12.

Insulating layers 22 and 23 are composed of an insulating material made of aluminum oxide to which a substance is added which, during sintering, is deposited at the grain boundaries of the aluminum oxide and represses the mobility of contamination ions.

The substance deposited at the grain boundaries of the aluminum oxide is an alkaline earth compound in the present case, i.e., a barium aluminate such as BaAl₂O₄ or BaAl₄O₇, or celsian. The concentration of the alkaline earth compound in the insulating layer may be, for example, 10 percent by weight. Due to the addition of the alkaline earth compound, insulating layers 22 and 23 have low residual conductivity, so that the danger of signal interferences by the heater is negligible.

1-6. (canceled)

7. An insulating material for an electric component, comprising:
sintered aluminum oxide; and
an additional substance added to the aluminum oxide, wherein the additional substance is deposited at the grain boundaries of the aluminum oxide and configured to repress the mobility of ions.

8. The insulating material of claim 7, wherein the additional substance is made of at least one alkaline earth compound.

9. The insulating material of claim 8, wherein the alkaline earth compound is at least one of a barium compound and a strontium compound.

10. The insulating material of claim 8, wherein the alkaline earth compound includes at least one of a barium sulfate, a barium aluminate, a barium hexaaluminate, celsian, a celsian glass, and a slawsonite glass on a basis of an alkaline earth metal, the alkline earth metal including at least one of strontium and barium.

11. The insulating material of claim 10, wherein the barium aluminate is one of BaAl₂O₄ and BaAl₄O₇.

12. The insulating material of claim 7, wherein the insulating material is configured as an insulating layer including the additional substance in a concentration of up to 50 percent by weight.

13. The insulating material of claim 12, wherein the concentration of the additional substance is between 1 percent by weight and 20 percent by weight.

14. A gas sensor, comprising:
at least one layer including a ceramic solid electrolyte;
at least two measuring electrodes; and
at least one insulating layer for an electric component, wherein the insulating layer includes a sintered aluminum oxide and an additional substance added to the aluminum oxide, the additional substance deposited at the grain boundaries of the aluminum oxide and configured to repress the mobility of ions.
